(19) United States
(12) Patent Application Publication
(10) Pub. No.: US 2005/0010580 A1
(43) Pub. Date: Jan. 13, 2005

(54) Data processing system

(75) Inventor: Paul Damon Lancefield, London (GB)

Correspondence Address: ROTHWELL, FIGG, ERNST & MANBECK, P.C., 1425 K STREET, N.W., SUITE 800, WASHINGTON, DC, 20005, US

(73) Assignee: Infinite Reason Ltd., London (GB)

(21) Appl. No.: 10/834,368

(22) Filed: Apr. 29, 2004

(30) Foreign Application Priority Data
Apr. 29, 2003 (GB) GB 0309802.7

(51) Int. Cl. G06F 7/00

(52) U.S. Cl. 707/100

(57) ABSTRACT

An object oriented data processing system configured to store objects and to store definitions of relationships between the objects, and to process the objects in accordance with the defined relationships, the system being configured so as to support definitions of relationships of two types; a first type of relationship whereby objects can be related such that one object in a hierarchy related to another object by a relationship of the first type is deemed to belong to a set defined by the other object; and a second type of relationship distinct from the first type of relationship and whereby objects can be hierarchically related such that a child object related to a parent object by a relationship of the second type is deemed to inherit characteristics of the parent object and, to an extent specified in the relationship of the second type, a proportion of a characteristic of a further object related to the said parent object by a relationship of the first type.

This invention relates to a data processing system that supports object relationships, for example as implemented in a database, especially a database intended for analysing intellectual property data.

The number of patent threats and software patent threats in particular is growing at an increasing rate. Now many software businesses register patents to cover potential new products and services as a matter of course in order to acquire additional market leverage and advantage. There are known systems for analysing groups of patents and graphically presenting the results.

The valuation of intangible assets has become a significant accounting issue. It can be difficult to determine if the monetary value placed on any given piece of IPR is a realistic one. Separate businesses may give a competitive representation of the monetary value of their IPR such that the sum of all represented monetary value exceeds total monies realistically attributable to IPR in a given market. It would be advantageous for the investment community if there could be system for representing a realistic monetary value for IPR, a system where it is demonstrable that double counting of total market value is eliminated.

A further problem is that software in particular is often extremely difficult to categorise. Consequently it is difficult for a researcher working on a given product to find prior art with confidence. Any list of IPC (international patent classification) categories sufficiently broad to catch all instances of prior art is likely to be so broad as to contain many irrelevant patents. On the other hand any list of IPC categories sufficiently narrow to limit lists of patents to a digestible size is likely to miss relevant patents.

Recently, consolidated Internet-based patent database services have become commercially available. Micropatent (www.micropatent.com), Delphion (www.delphion.com) and M-CAM Doors (www.m-cam.com) are three examples. These databases allow a researcher to search for documents using Boolean search expressions. Boolean searches allow the selection of only the documents which match user defined search criteria or logical expressions. When conducting a general search this usually involves searching for documents that contain certain words, and the search algorithm may be refined so that the documents returned are graded according to how close the words are together. (For example, many documents would contain the words “patent” and “database” but far fewer would contain the two immediately next to each other or very close together). These searches greatly improve the researcher's efficacy and if constructed properly will yield a far higher proportion of relevant results than a category search. Boolean searches increase the confidence in the validity of the research because they are not limited by category and a well formed Boolean search is more likely to pick up relevant documents from unexpected categories.

However, even Boolean searches are not without problems. When constructing a Boolean search it is difficult to be sure in advance if the search, as it has been constructed, contains keywords that are representative of the kinds of documents the researcher will be interested in. Most such searches rely upon searching for documents that match certain keywords. If too few words are included important documents might be missed. If too many are included, many irrelevant documents are returned, all of which need to be evaluated and consume the researcher's time (a precious resource).

In summary: Boolean searching or other forms of searching based on semantic content is deficient as a method for identifying related prior art for the simple reason that the relevance one patent holds to another is not a function of its semantic content. The IPC categorisation does not much improve matters because the category to which a patent should be assigned is very often ambiguous.

That the issues identified above are recognised as a problem within the innovation business is attested by the fact that technologies have been developed and marketed to address the problem.

On Delphion, for example, advanced technologies such as text-clustering are made available to the researcher at a premium charge. With text clustering, a researcher may execute a broad based search and then look for similarities in phraseology or language use within documents in the result set, grouping documents together that appear to have a common structure. Using text clustering the researcher can quickly find related documents that are of interest to the subject searched for, but still the researcher cannot be entirely confident all relevant documents have been found. Text clustering is suitable for quickly finding interesting related material that may be prior art but not so useful for providing a comprehensive audit of all related material that may be prior art. Other technologies using semantic analysis for the searching of unstructured documents are available, but suffer similar limitations on their practical application.

Existing searching techniques present a number of problems;
How to identify and track groups of artefacts possessing similar but complex technical dependencies, whilst limiting data data duplication and maintaining classification integrity.
How to enable a searcher to readily categorise documents in a meaningful way that aids the process of threat evaluation for companies or organisations.
How to evaluate the patentability of an idea with relatively little search effort, preferably in a way that allows that evaluation work to be useful for research on other prior art in the same area.
How to reduce time spent modelling solutions in a particular technical field, enable information on publications in that field to be captured easily and allow the relationship between an innovation proposal (e.g. invention) and prior art to be readily determined to avoid duplication and reduce the risk of infringement and reduce time spent preparing a patent application.

It would be desirable for there to be a data analysis tool and/or relationships to be defined and/or available between objects in a system so that some or all of these problems may be at least partially addressed.

Object models may be used to identify the technological dependencies held by inventions. Object models provide a useful means to aid comprehension when executing software or hardware designs. It is an objective of many object modelling systems to allow the modelling of complex systems through the elaboration of a basic design until it defines a functionally complete solution.

Inventions from the field of engineering may be partially described through identifying the technology dependencies they share with other inventions. Identification of shared technology dependencies provides a good way of classifying inventions likely to deal with similar subject matter. Shared technology dependencies may be modelled using existing software modelling solutions; however, as noted, it is an objective of most if not all of these solutions to allow elaboration of a design until it provides a functionally complete system.

If the technology dependencies an invention holds are modelled in too much detail, the number of inventions found to share the same dependencies will be minimal. If, on the other hand, the technology dependencies an invention holds are only partially identified (e.g. with too little detail) then the number of related inventions is great. For example many inventions have a dependency on the services of a general processing unit. However if the technology dependency identified in a model is for e.g. a GPU and nothing more, millions of inventions will relate to the object.

One solution is to allow the identification of groups of technology dependencies using objects in a hierarchy. This may be a class hierarchy as understood in the field of software engineering and object oriented programming, or another form of hierarchy. Objects “further down” the hierarchy through having relationships with objects “higher up” in the hierarchy represent ever more specific combinations of technical dependency. Through a process of researching documented inventions, objects representing the inventions are related to the hierarchy objects with which they have the most technical dependencies in common. If, over time, very many inventions come to be related to a first object, its value for the purpose of identifying similar inventions may lessen, or at least, the value of the hierarchy may be improved by seeking to define new hierarchy objects representing more specific sets of shared dependencies.

In this event the researcher looks across all the inventions related to the first object, identifies a subset of those which share more specific technical features or dependencies than the current parent object represents, creates a second, more specific object related to the first object (“further down” the hierarchy) and makes the subset of inventions children of the second more specific object.

A difficulty faced when adopting this solution is that there may be a trade-off between over complexity and ambiguous classification. If the hierarchy is too simple, there may be multiple objects an invention can be interpreted to share dependencies with, which means, strictly speaking, it should be related to more than one object. This introduces a form of ambiguity already found in the library style classification systems the hierarchy is supposed to improve upon. However, if the hierarchy is too complex, it may then be difficult to navigate and cognition of the technology dependencies identified by the hierarchy objects can be undermined. A further problem is that the differences between objects may be unobvious from the name or title given to the object alone and it can be difficult to remember the detailed description of the dependencies the object defines or holds by virtue of the other objects it is related to.

Similar problems can be met in modelling relationships in other fields.

It would be desirable to be able to address these problems, preferably by means of the relationships defined and/or available between objects in a system.

According to one aspect of the present invention there is provided an object oriented data processing system configured to store objects and to store definitions of relationships between the objects, and to process the objects in accordance with the defined relationships, the system being configured so as to support definitions of relationships of two types; a first type of relationship whereby objects can be related such that one object in a hierarchy related to another object by a relationship of the first type is deemed to belong to a set defined by the other object; and a second type of relationship distinct from the first type of relationship and whereby objects can be hierarchically related such that a child object related to a parent object by a relationship of the second type is deemed to inherit characteristics of the parent object and, to an extent specified in the relationship of the second type, a proportion of a characteristic of a further object related to the said parent object by a relationship of the first type.

In the context of the present invention, the terms “parent” and “child” may refer to any pair of objects which are related by a relationship of the second type; that is, a parent may be any object in a hierarchy which has an object related to it by a relationship of the second type, the related object being below the parent object in the hierarchy. Similarly, a child object may be any object which is related by a relationship of the second type to an object above it in a hierarchy.

Preferred features of the present invention are defined in the accompanying claims.

The present invention will now be described by way of example with reference to the accompanying drawings.

In the drawings:

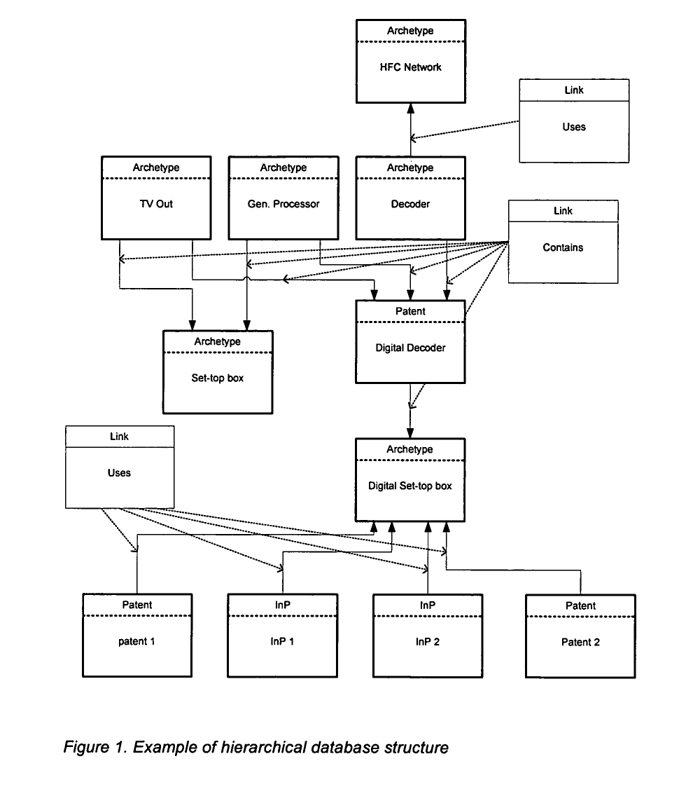

FIG. 1 is an example of a hierarchical database structure;

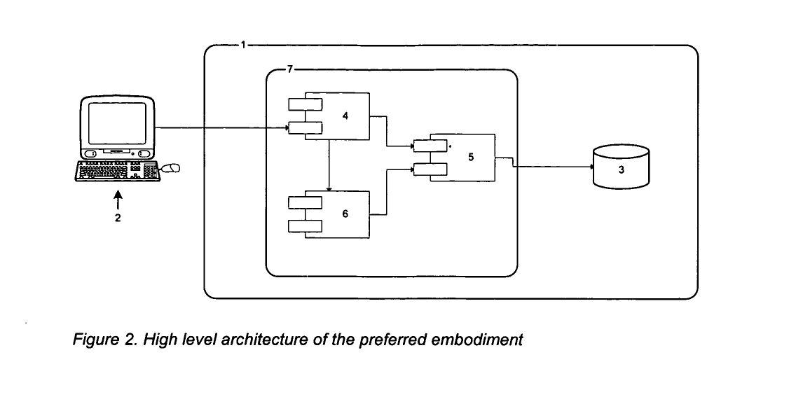

FIG. 2 shows schematically the high level architecture of the preferred embodiment;

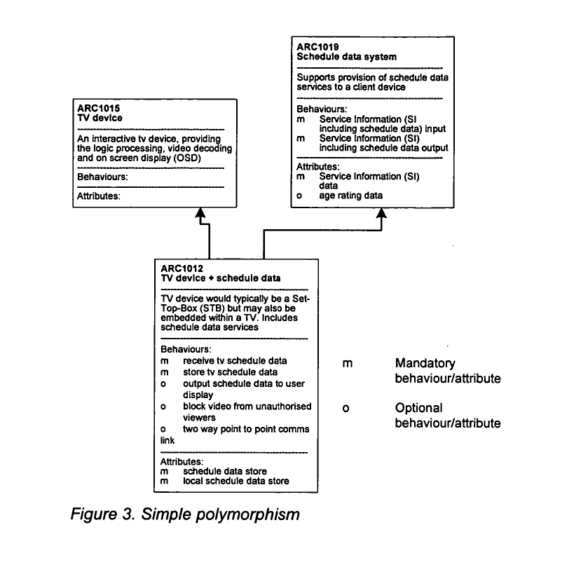

FIG. 3 illustrates simple polymorphism;

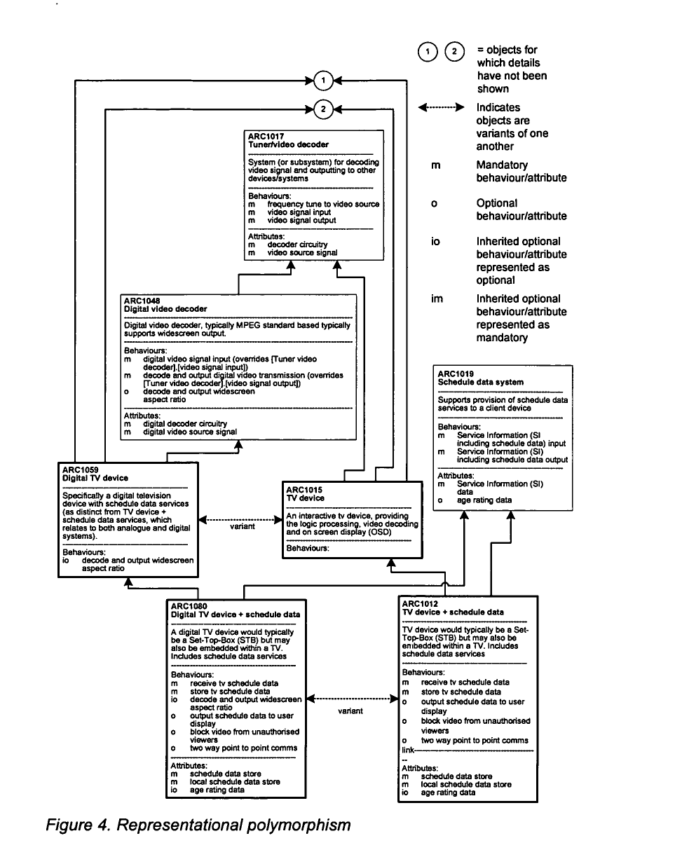

FIG. 4 illustrates representational polymorphism;

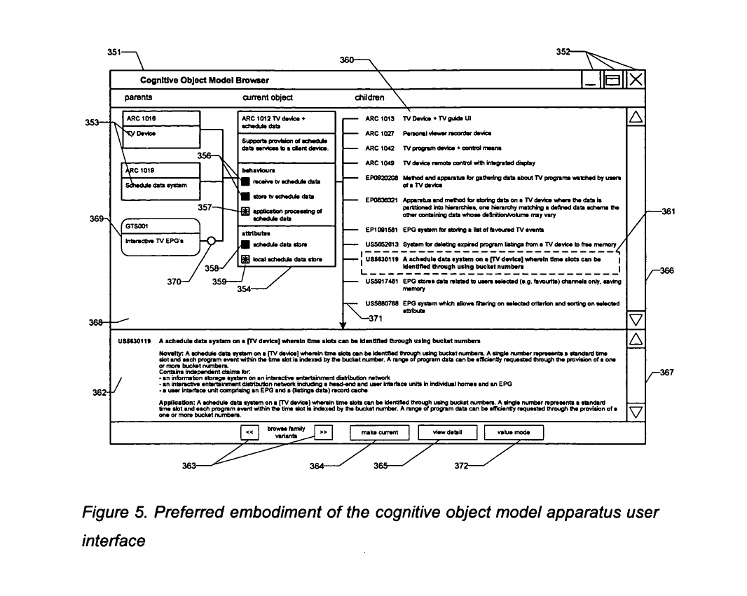

FIG. 5 shows a user interface for a cognitive object model apparatus in the preferred embodiment;

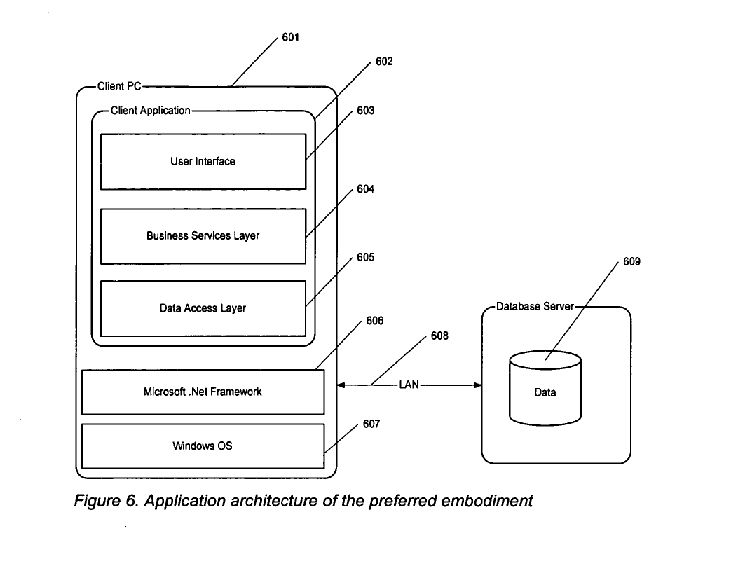

FIG. 6 shows an application architecture of the preferred embodiment;

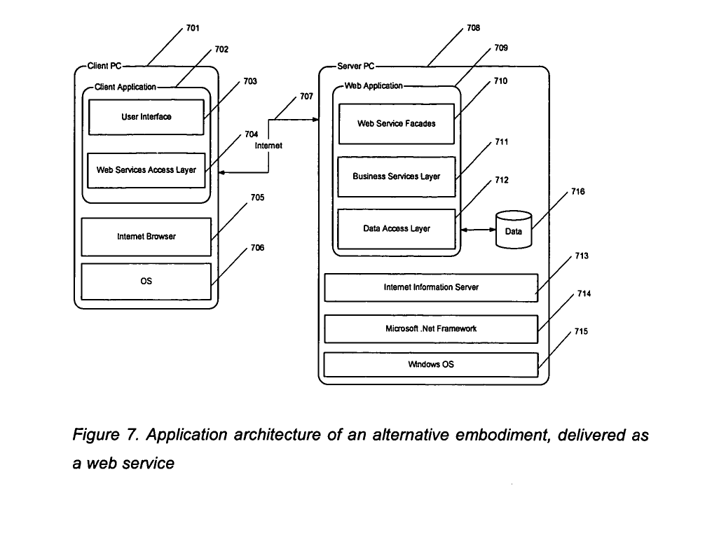

FIG. 7 shows an application architecture of an alternative embodiment, delivered as a web service;

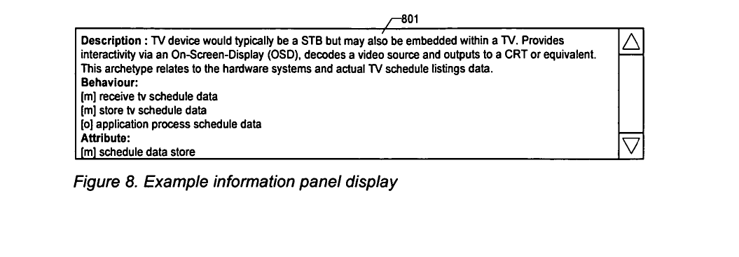

FIG. 8 shows an exemplary Information Panel display;

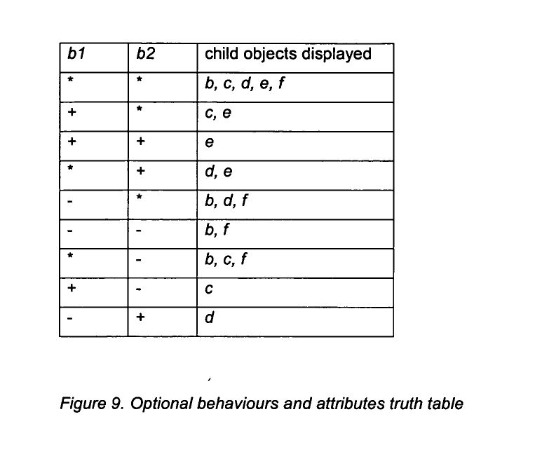

FIG. 9 shows an optional behaviours and attributes truth table;

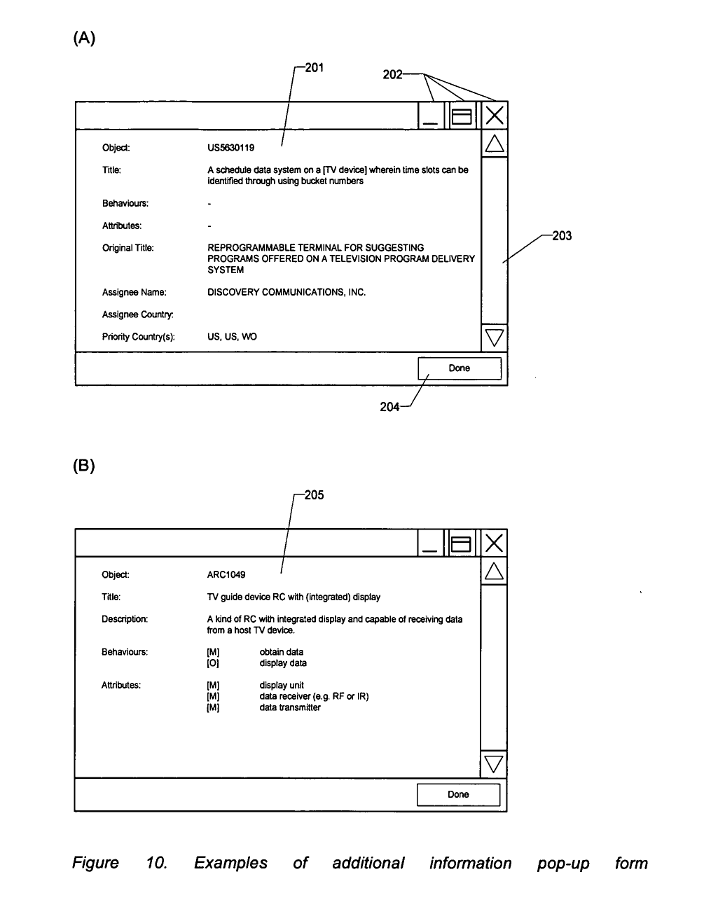

FIG. 10 shows an exemplary additional information form, displaying additional information about patent classes or archetype classes;

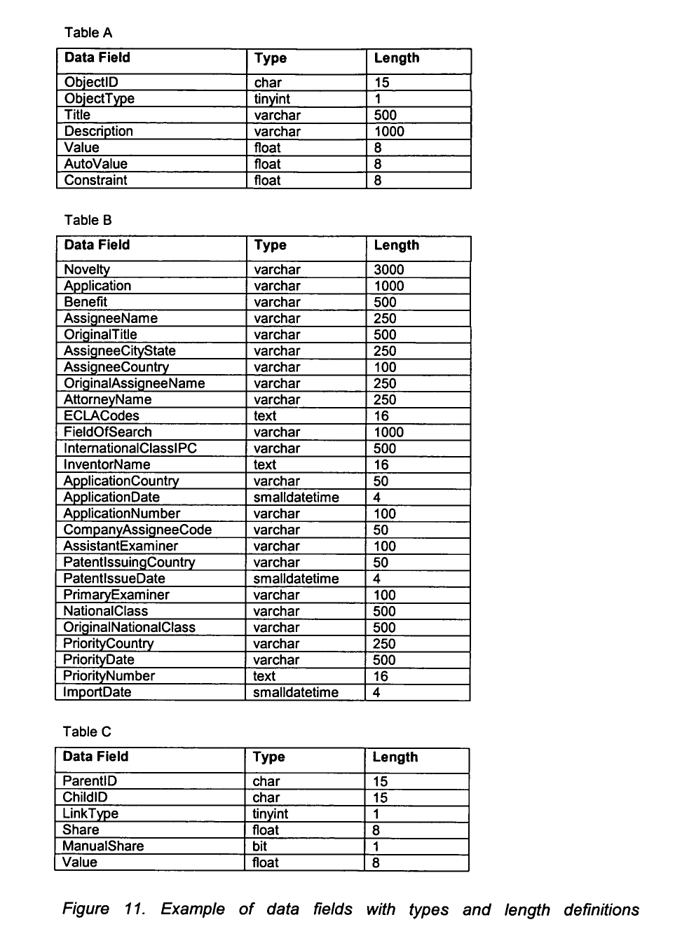

FIG. 11 shows exemplary data fields with type and length definitions;

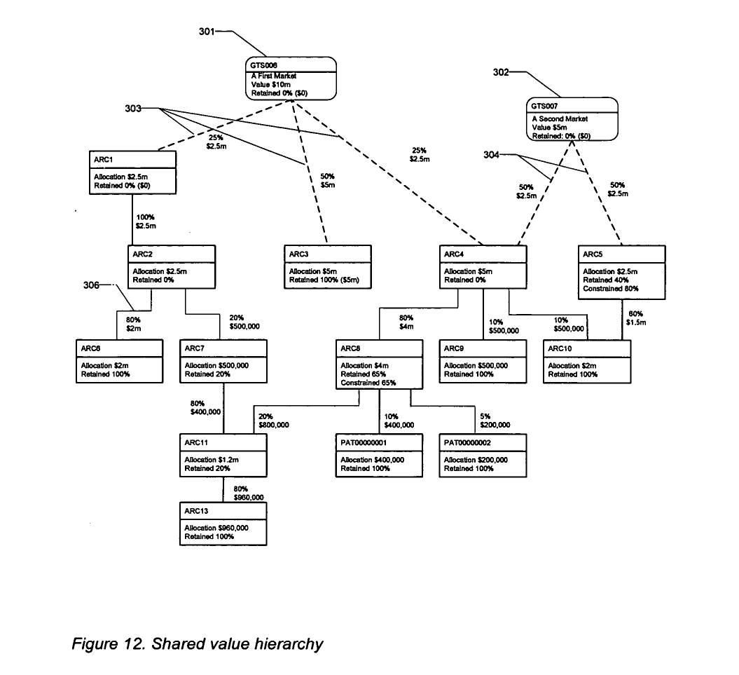

FIG. 12 shows a shared value hierarchy;

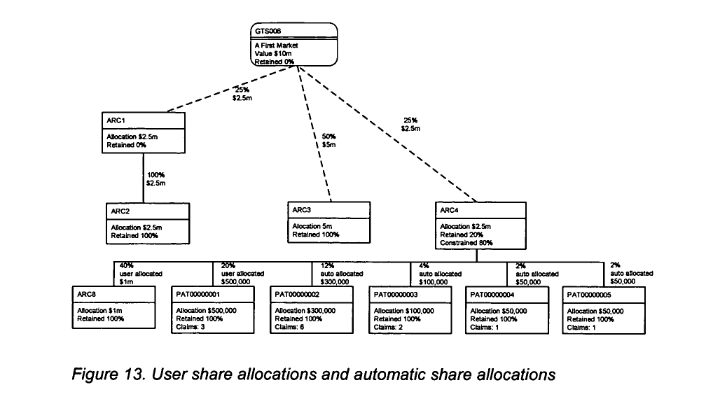

FIG. 13 shows user share allocations and automatic share allocations in a shared value hierarchy;

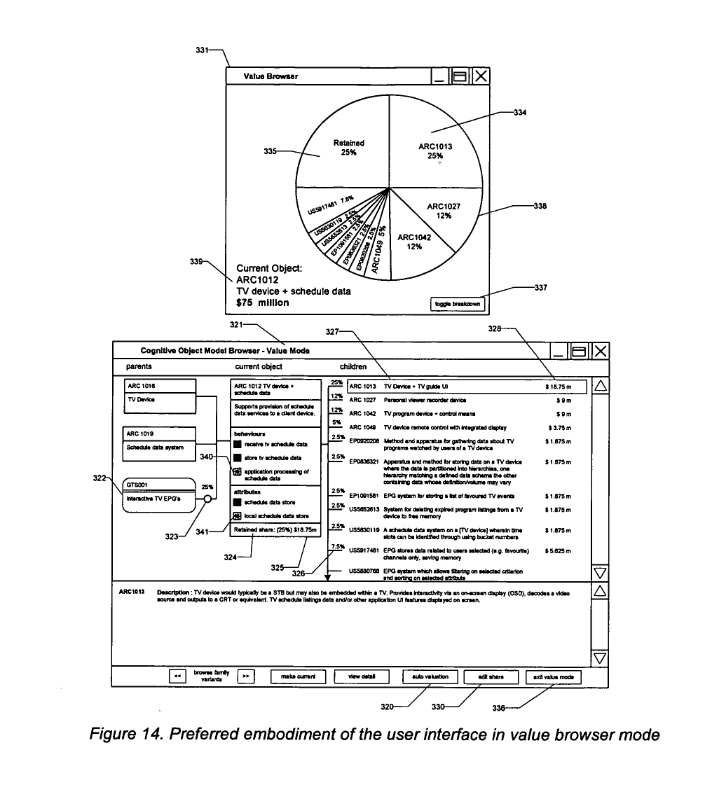

FIG. 14 shows the user interface of the preferred embodiment in value browser mode;

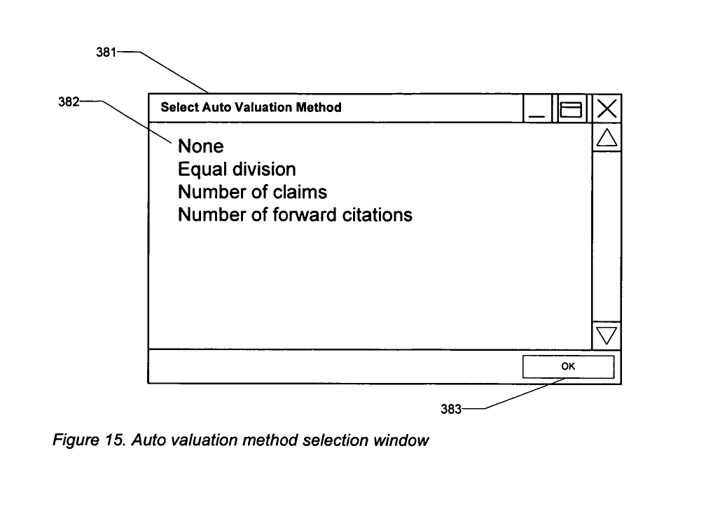

FIG. 15 shows an auto valuation method selection window;

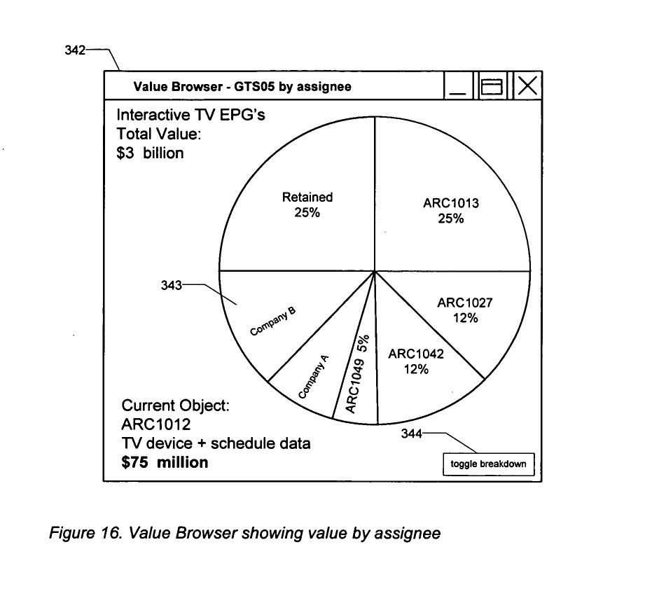

FIG. 16 shows the Value Browser showing a graph of value by assignee.

In terms of IPR ownership, it is more valuable to own a right to exploit a more general functionality than a more specific version of the functionality. As a general rule, parent objects in an object model represent more general functionality than their children. It then follows that for a given market, ownership of the right to use any functionality represented by a child object in an object model represents a lesser market value than ownership of the right to use its parent. Put another way, when patented inventions are categorised in an object model, the hierarchical structure of the model also reflects a hierarchy of real world value.

The present invention uses this insight by allowing technology objects that are a part of an object model hierarchy to be linked to a total market value and for each linked object to be allocated a share of the market value (which may be expressed as a value between 0 and 1). Since the values represent a share of the total market value, the sum of all the values used to define each object's share cannot exceed 1, though, within this constraint, the allocation given to any object may be user defined. Typically this would mean that if there are three objects and a user allocates a share of 1 to the first, the remaining two objects must be allocated a value of 0. If however 0.9 is allocated to the first object, the second two can be allocated any positive decimal values provided they add up to 0.1 or less.

It will be recognised that allocated shares may be represented to the user as a floating point decimal figure between and including 0 and 1 or as a percentage, such that a share of 0.75 is represented to the user as 75%, and 0.251 as 25.1%. The mode of representation is immaterial to the claimed invention and a person skilled in the art of software programming will be able to convert between the two forms of representation.

The allocated share is used to calculate the total market value each object represents. The invention further allows a share of the value of the object (i.e. a share of the allocated share) to be allocated to each child of the object. For each object a share of the value it receives can be allocated to its children. Thus if object a is a parent to object b which is a parent to object c, and it a receives a share of 0.5 and allocates a share of 0.5 to b, which in turn allocates a share of 0.5 to c, and if the total market value is 8, then the monetary value of c will be 8×0.5×0.5×0.5, or 1.

According to an embodiment of the present invention an object can be configured such that the share of the object's value inheritable in toto by its children is constrained to a maximum share value input by the user (which is referred to hereafter as a constrained allocation). According to an embodiment of the invention, if the sum of the shares a parent object allocates to each of its child objects add up to less than 1, the parent object retains 1 minus the sum of the allocated shares. For our purposes this is called the retained share.

The object hierarchy, which may represent an object model, is polymorphic and so a child object may inherit a share of value from more than one parent. In this case in the preferred embodiment the total value of the object is the sum of values received from each inherited share and the object's children inherit a share of the total value.

In the present specification the term “archetype” refers to an abstract generalised reference to a kind of technology (for example a CPU), whereas an “artefact” refers to an actual instantiation of a technology (for example an Intel Pentium III 266 MHz CPU). Technology artefacts can include (but are not limited to) actual inventions, the specific embodiment or article described by a document but which has not yet been built, innovation proposals (proposed inventions as yet to be registered) or actual technical hardware/software systems fulfilling a specifiable function. Archetypes represent abstract systems and usually lack implementation detail, whereas artefacts represent either actual systems or documented systems that have been fully described such that the system can be built by someone skilled in the art.

The present system can store, track and analyse information about intellectual property archetypes/artefacts that have many complex but similar technical dependencies on other technology artefacts/archetypes. The system comprises an engine, which can most conveniently be embodied in software, arranged to interrelate data in the form of a recombinant object hierarchy (“the hierarchy”), which contains objects denoting actual archetypes and artefacts and combinations of archetypes and artefacts. The engine ensures that the information stored representing relationships between artefacts and archetypes is logically consistent. The engine is a tool for intellectual property research that can be used in the context of e.g. an object-relational database to establish an intelligent store for records of intellectual property artefacts/archetypes. Once the store has been established and a comprehensive set of objects entered in the system, a database utilising the engine can be used to quickly identify prior art that is relevant to a given archetype or artefact. By using an object design consistent with polymorphism the engine minimises the duplication of data, reduces the time a user requires to enter data and reduces the complexity of user searches. The engine has been designed specifically but not exclusively for tracking intellectual property related to digital technologies and can be integrated into a standard relational database, or an object-relational database which provides additional database functionality. It can also be integrated to great effect with object modelling tools.

A recombinant object hierarchy is a hierarchy of diverse object types united by a primary key (in this case an object ID).

In the context of the present system the term “object” may refer to a software object or class as understood in the art of object oriented programming, a record object in an object-relational based database or, if certain additional methods described below are implemented, a record in a standard relational database. In the engine a variety of object types are used to denote a variety of technology archetypes and artefacts. Objects of a type are instantiated by a user (which may be a person or external system), and as defined by a specified object type can contain certain kinds of data about the archetype/artefact denoted. The objects within the hierarchy can be used to track the kind of technical dependency or logical relationship a specific archetype or artefact may have on another technology archetype or artefact.

In the present system a record may for example be a database record, which adheres to a database schema, or a flat file capable of being supplied with a definition, a computer file, or a marked up file such as an XML document.

In one embodiment of the system the hierarchy is composed of objects matching at least the following object types:

| | |
|---|---|
| Patent Class | An object denoting a patent or patent application document. The |
| | patent object includes an identifier that uniquely identifies the |
| | document, for example its publication number. The object may |
| | include a description of the document and/or its contents. The |
| | object may also include features denoting behaviours and or |
| | variables/attributes as understood in the art of object oriented |
| | programming. |
| Archetype Class | An object denoting an archetypical technology system |
| | solution or service (in contradistinction to an artefact). The |
| | archetype class is reserved for describing systems at a high |
| | level and where there is no intention or requirement for |
| | providing specific implementation details for the technology |
| | described. Archetype classes can be said to characterise a |
| | technology. The object may include a description of the |
| | technology solution or service. The object may also include |
| | features denoting behaviours and or variables/attributes as |
| | understood in the art of object oriented programming. |
| Classification Object | A classification object can represent a category of a subject |
| | matter classification such as the IPC, or it may be used to |
| | represent a defined technology sector, or market. Links |
| | from this type of object to other objects can be used to |
| | indicate they fall within the category or for other purposes |
| | defined later in this document. |

Each of the three objects above includes a unique identification field (object ID) by which it can be unambiguously identified for the purpose of searching, storing search results or other lists of objects.

| | |
|---|---|
| Link Object | An object containing information linking one object to |
| | another (an object-object link) or linking one object to a |
| | feature of another object, (an object-feature link) and |
| | providing additional information about the nature of the |
| | relationship between the objects. The link object includes |
| | the identities of the objects that are linked for object-object |
| | links or the identity of the object and the identity of the |
| | feature that are linked for object-feature links, and an |
| | indication of the type of relationship that it defines. |

Link objects are used to define links between objects. Each feature also contains a unique identification field by which it can be unambiguously identified for the purpose of searching, storing search results or lists of features, and for defining links between objects and features.

The patent class and the archetype class could be combined into a single type of object. This could be a polymorphic object including an attribute that can be set to indicate whether the subject of the object is an artefact or not or provided with an interface to an artefact object type. Thus the polymorphic type of object could take two or more forms.

In an embodiment objects may optionally include an artefact attribute which can be set to true or false to indicate whether or not the object is an artefact.

The availability of link objects provides a means for a user to define relationships between objects (object-object links) and so to establish a hierarchy between them. The link object allows the following relationships to be denoted by object-object links:

| | |
|---|---|
| “contains” | If object y contains an object z, z inherits at least the |
| | mandatory features (whether behaviours and |
| | variables/attributes) of y. In the preferred embodiment |
| | object z then does not require object-feature links to |
| | each of object y's mandatory features to be treated as |
| | having the features. |
| “uses” | When an object y uses an object x, object y does not |
| | make any of object x's mandatory or optional features |
| | available to its child objects (e.g. any objects it |
| | contains). For this kind of object-object link, object y |
| | would typically be an artefact. |
| “holds” | The “holds” link type is used to indicate non-technical |
| | object-object relationships such as when an object x is |
| | used to group objects y and z. |
| “of interest to” | The “of interest to” type is used to indicate non-technical |
| | object-object relationships such that a child object y |
| | could be interesting in relation to a parent object y. |

The link object also allows the definition of object-feature links and allows the following relationships to be denoted for each object-feature links:

| | |
|---|---|
| “mandatory” | When an object x is linked to a feature z of object y with |
| | a mandatory link, it inherits the feature and represents it |
| | as mandatory. |
| “optional” | When an object x is linked to a feature z of object y with |
| | an optional link, it represents the feature z as an |
| | optional feature and the object x is said to represent |
| | variants. |

The nomenclature of the objects and the relationships that are available is arbitrary, and other names could be used.

When a hierarchy between objects is being defined the system provides a means for checking the hierarchy so as to maintain its logical integrity, either through allowing only relationships consistent with the logical rules of the hierarchy or through warning/indicating to a user (e.g. a human or an external system) that those rules will be violated if they proceed with defining the relationship. The rules apply to fully describable relationships. The logical rules include:
1. If an object x is said to contain an object y and y is said to contain an object z, the system will not allow z to contain y or for z to contain x—the system may automatically provide a warning to a user that relationship rules will be violated if the user attempts to define a relationship such that z is said to contain y or if z is said to contain x.
2. Any object which is said to contain an archetype object must itself be an archetype.
3. If an object y uses, is held by or is of interest to an object x, y is not allowed to inherit object x's optional features. In other words y is not allowed an object-feature link with an attribute of x.

If the system detects an attempt to define a relationship that violates one or more of these rules then it may issue a warning, but allow the user to override the rule and define the relationship anyway, or it may prevent the relationship from being defined. Instead of (or in addition to) checking the hierarchy at the time when relationships are entered, the system may provide a facility for checking the whole or a part of a previously defined hierarchy for consistency with the rules.

FIG. 1 illustrates an example of an object hierarchy.

The system provides a means for definitions of the objects to be entered. It should be noted that the standardised nature of the objects means that the data can readily be entered by a non-technical user. After any verification, the objects are stored in a database as a recombinant object hierarchy.

The system further provides a means for a user to query the database and to selectively retrieve and display information based on the stored hierarchy. Non-limiting examples of the types of query that may be performed are as follows:
1. The system allows a user to selectively output or display all child object members of the hierarchy that have a relationship of a specified type with a specified member of the hierarchy.
2. The system allows a user to select an object and to then retrieve the details of that object and its immediate relations.

Object hierarchies may become extremely large, where an object y may be directly and indirectly used by (as defined above) or contained by a potentially unlimited number of other objects (e.g. if y is used by b and b is used by x then y is used by x, but this fact is determined indirectly by the relationships that pertain between y, b and x and any objects that may contain y, b and x). The system may also provide a means to constrain the results to those that are less than a given number of steps from the object that is the subject of the search.

The results of such queries may be filtered according to filter definitions made by a user. The available filter definitions could include:
The system allows any output data to be filtered by object type. A user may select which types of object should be Included In the output.

The system is preferably arranged to allow for graphical display of the hierarchical relationship between selected objects, for example as shown in FIG. 1. This can permit a user to easily understand the relationships between objects.

Additional objects may be accommodated, which can add additional functionality to the database. These objects may include:

| | |
|---|---|
| Innovation Proposal | These are objects denoting the artefact |
| (InP) Objects | described by a design proposal or description of |
| | a technical invention. The object preferably |
| | includes a description of the proposal or |
| | description, or a link to such a description. |
| Artefact Objects | An object denoting an existing technology |
| | artefact that has not been subject to a patent or |
| | innovation proposal. The object preferably |
| | includes a description of the artefact, or a link to |
| | such a description. |

FIG. 2 shows the high level architecture of the preferred embodiment.

In the system of FIG. 2, a database computer (1) comprises a processing section (7) and a storage unit (3). A user interface (2) is provided whereby a user can provide data to the system computer and view output data. The user interface is linked to an input processor (4), which receives input data intended as entries in the database. The input processor forms the input data into database records of the correct format and performs error checks to ensure that the input data obey the rules set out above. If the input data comply with the rules the input processor enters them into the database, which is stored in storage unit (3). When a query is to be performed the user enters the query using the user interface (2) and the query passes to a query engine (5). The query engine applies the query to the database and passes the results of the query back to the user interface for display. A control unit (6) is provided to supervise the operation of the input processor (4) and the query unit (5), for example to ensure consistency in the use of the database.

References herein to patents should be interpreted as including patent applications and other similar forms of intellectual property protection.

References to documents include references to computer-stored documents and web pages or XML documents (either of which could in turn reference further documents).

An arrangement for providing relationships between objects that can help to model the relationships between related entities will now be described. Such an arrangement may be used in the system described above, or in another type of system.

Software languages implementing the object-oriented paradigm support the definition of software objects (components) through classes (or object templates) which may have behaviours (sometimes called functions or methods) and attributes (sometimes called variables). Moreover in the object-oriented paradigm objects implement inheritance such that any given object may be a parent to, or the child of another object. In general, a child object inherits the behaviours and variables/attributes of its parent object, and may define one or more of its own more specific behaviours and variables/attributes that are either additional to those of the parent, or a modification of those of the parent. In the latter case the child object features (behaviours and variables/attributes) are said to override the corresponding parent object features and any child object of this first child object will inherit the overridden feature and not the original parent feature (though in most object oriented systems it is still possible for other objects using a child object to access a parent feature that has been overridden by the child).

A great benefit of object-oriented programming languages is that when other code or another system utilises the services provided by a software object, it doesn't have to be concerned with the internal design or logical procedures within the object. Provided the object is well designed, all an external system needs to understand is the behaviour (and sometimes the variables/attributes) of the object (as defined by the class).

The object-oriented paradigm therefore hides unnecessary complexity inside component objects and this aids high-level understanding of how a given system (or architecture) works; the significant factors being the object behaviours (methods or functions) that might be initiated or controlled. This helps the analyst to “see the forest for the trees.”

Object modelling systems allow the presentation of such object relationships without requiring the writing of actual code (i.e. a functional object). Moreover object modelling systems can be used to analyse all manner of technical artefacts, whether or not they use components designed using the object-oriented paradigm. In an object model, whether an object is said to have inherited features may not be evident by inspecting the immediate properties of the object but may require looking to see if the parent has a parent containing those features. By default, through the representation of an inheritance relationship, a child class would be seen to inherit all the features of a parent class.

The present arrangement is especially suitable for an object modelling apparatus, supporting a novel form of object modelling that is particularly appropriate for the rapid modelling of a large number of diverse systems at a high level. The apparatus implements novel features supporting the modelling of technology systems, allowing the high level identification of e.g. enabling technologies, using classes, behaviours (and optionally attributes) where those dependencies might be shared by a large number of technology artefacts. The arrangement has particular advantages in helping users to identify technology artefacts dealing with similar subject matter out of large numbers of technology artefacts.

The present arrangement/apparatus allows a child class—which might be representative of a technology artefact such as an invention—to be linked to a parent class situated within an inheritance hierarchy. The parent class represents behaviours and (optionally) attributes that on analysis (a) must be present in any system instantiating the artefact/invention and (b) are likely to be common to more than one artefact/invention. In accordance with the object-oriented paradigm the parent class represents features and may be a child of other classes higher up the inheritance hierarchy. However the apparatus supports a novel representation of an object model where a single class in the model can represent variable groups of features. Each class in the hierarchy represents at least a base or mandatory set of features. However each class may also represent optional features. In this way a single class in the hierarchy may be representative of multiple possible real-world implementations of a technology (henceforth, such classes will be said to support representational polymorphism and the distinct classes that can be represented by a representation polymorphic object called variants). All children of a class with mandatory and optional features inherit the class's mandatory features; however any given child class may also selectively inherit the optional features and selectively determine whether the feature should be represented (to classes “below” it in the inheritance hierarchy) as mandatory or optional. Using the apparatus a single identifiable parent class can be representative of multiple systems, archetypes, artefacts, configurations or sets of technology dependencies (variants).

To re-iterate: under the rules of the cognitive-object paradigm a second class that is a child of a first class does not automatically inherit the optional features of the first class. So for example if a first class presents a single optional feature—and consequently is representative of two variant classes—the second child class presenting no optional features does not automatically represent two variants by virtue of being a child of the first parent class. The second class may however selectively inherit the first class optional feature and present it as either optional (in which case it does then represent two variants) or mandatory.

Another aspect in an embodiment of the apparatus is simplified polymorphism as the term is understood in the object-oriented paradigm (and not to be confused with “representational polymorphism” defined above). In object-oriented design an object is said to be polymorphic when it can implement behaviours and/or variables/attributes from more than one parent object. In some current object-oriented systems an object may only inherit from more than one parent through implementing an interface class, a template defining a standard interface design through which the (second or more) parent objects and child object can communicate. However the cognitive object model embodied by the invention allows a class definition to inherit behaviours and variables/attributes directly from more than one parent, without requiring the definition or representation of an intermediating interface (though the possibility of defining such a class is not excluded).

FIG. 3 shows simple polymorphism. ARC1012 has two parent classes and inherits features from both (ARC1015 and ARC1019). When a first class meets certain criterion, it can be represented as one amongst a number of family variants. A family variant is determined to exist when a second class has an inheritance relationship such that it inherits mandatory features from the same number of classes as the first class and where those classes have the same lineage as the first class and where that class is not itself a parent or a child of the second class. The default inherited features however will vary in so far as some of the features between the two classes will be an adapted or overridden form of the features contained in the other class (a variant is then most usually a more or less specific form of the first class—we can only say “most usually” because it is always possible to override a defined feature with some wholly unrelated piece of functionality, though for the purposes of the cognitive object model this would most usually provide an indication of bad design). In an embodiment, inheritance is only supported by the “contains” link type. For the purpose of determining variants, all objects linked by link types other than “contains” are ignored.

FIG. 4 provides a view of a class hierarchy implementing representational polymorphism and also shows family variants. Note ARC1059 and ARC1012 are not family variants of each other because they do not share the same lineage. ARC1012 inherits from ARC1019 whereas ARC1059 does not. In one embodiment even if ARC1019 did not contain any behaviours and variables/attributes for ARC1012 to inherit, ARC1012 would still be deemed to inherit from ARC1019 and therefore to have a different lineage to ARC1059 and ARC1015. Whether the lineage a first class has is the same as that held by a second class may be determined by tracing each object's inheritance to the highest related parent classes each class inherits from and verifying if those parent classes are the same.

FIG. 4 also provides illustration of the selective inheritance of optional features. Class ARC1059 selectively inherits the behaviour “decode and output widescreen aspect ratio” from the parent class ARC1048.

Using the apparatus supporting the representation of variants, a class hierarchy with inheritance can typically represent a greater range of technical systems and functionality with fewer classes than object modelling tools utilising the standard representations of the object-oriented paradigm. When working at a high level (e.g. when surveying an entire technology sector) the representation of fewer classes helps to improve cognition of the salient features and optional configurations.

However, in an important regard, the representation the apparatus provides is wholly consistent with the object-oriented paradigm. As such transformational rules could be applied to translate a model represented by the cognitive object paradigm into a model in the object-oriented paradigm and vice versa.

In the preferred embodiment the apparatus provides a database (relational, object-relational or otherwise) for storing the class objects and the relationships between the classes of a model in the cognitive object paradigm. The apparatus supports in data the representation of inheritance and poylmorphism it additionally supports in representation in data of variant classes through supporting the definition and presentation of mandatory and optional features. In the preferred embodiment the apparatus allows a user to browse classes in an inheritance hierarchy, see parent and child relationships for each class, view the details related to those classes, add new classes, delete existing classes and amend classes.

The apparatus enforces a business (procedural) logic when dealing with the representations in data. In the preferred embodiment the logic allows a child object to be directly related to one or more parent objects. Unlike most software object-oriented languages the representation of polymorphism doesn't require the formal user definition and implementation of an interface class to intermediate relationships between the second or more parent classes. In an embodiment the apparatus enforces a further logic on the representation of inheritance where a child class always inherits at least the mandatory features of its parent class and can further inherit none, some or all its parent's optional features (e.g. on a selective basis). Further, for each optional feature a child class selectively inherits from its parent, it can be determined on a selective basis whether the feature will be represented by that class as mandatory or optional. If it is represented as mandatory, that feature no longer provides an optional variant to any children of the child object (i.e. the determination that the feature is mandatory overrides any parent classes representation of the feature as optional).

The apparatus provides a procedural logic to determine the identity of directly related child-classes for any first given class, according to a number of criteria:
a. Each child class inheriting at least the first class's mandatory features regardless of whether the child object inherits the additional optional features as mandatory or as optional. This will return any class that is a direct child of any and all the variants of the first given class.
b. Each child class inheriting the first given class's mandatory features and one or more specified features from the first given class's optional features to be represented as either mandatory or optional by the child class for at least a select specific list of the first given class's optional features.
c. Each child object inheriting the first given class's mandatory features and that inherits optional features from the first class to be represented as mandatory by the child for at least a select specific list of the first given class's optional features.
d. Each child class inheriting the first given class's mandatory features only and that does not inherit any additional optional features.
e. Each child class inheriting the first given class's mandatory features only and that does not inherit any additional optional features as mandatory.
f. Each child class inheriting the first given class's mandatory features and one or more specified features from the first given class's optional features to be represented as either mandatory or optional by the child class but that inherits no more features than those specified.
g. Each child class inheriting the first given class's mandatory features and one or more specified features from the first given class's optional features but that inherits no more optional features to be presented as mandatory than those specified.
   Other options may also be available.

In one embodiment the apparatus contains a procedural logic for determining the inherited features of a class through inspecting the defined features of each of its parent class, aggregating those features but ignoring any overridden features. In the embodiment some of the classes are representative of inventions described by patent documents (known henceforth as invention classes).

In an embodiment, the apparatus contains a procedural logic to determine if any given class has children.

In the preferred embodiment the apparatus has an interface for obtaining patent data from a database of patent data.

Not all object types support behaviours and variables/attributes. In one embodiment only patent objects and archetype objects support the definition of behaviours and variables/attributes.

In the preferred embodiment the output may be directed to a VDU and incorporated within a user interface.

FIG. 5 shows the user interface arrangement of the preferred embodiment. The user interface window (351) shows a graphical object browser allowing a user to navigate a graphical representation of an inheritance hierarchy in the cognitive object paradigm. The browser may be used as part of a larger application and on being invoked may be passed an initial object identifier to determine the currently selected object (the diagram illustrates (354) an archetype class object “ARC1012 TV device+schedule data”). In other embodiments the interface may also provide access to additional user interfaces, such as pop-up window forms, for allowing the user to add new classes, edit classes, and find classes. Any object may be designated as the currently selected object, in which case it will be shown at the position occupied by (354) under the current object title.

(352) is a set of industry standard window control buttons for minimising, maximising and closing the window.

If the current object has one or more parent objects, they will be shown to the left. FIG. 5 provides illustration of three such parent objects indicated by (353) and (369).

If the current object has one or more child objects, they will be shown to the right (360) under the heading “children”. It can be seen that the current object has many such child objects.

For convenience of browsing the presentation of parent objects, the current object and child objects is different. Parent objects display only the ObjectID and Title fields. The current object displays an ObjectID, Title, and Description fields and, if the object type supports them, any defined behaviours and variables/attributes in their respective panels.

The child objects show only the child object ObjectID and Title displayed in a format designed to ease browsing if there is a long list of child objects.

In addition to a currently selected object, any object whether in the parents position on the left of the interface, the current object position in the middle of the interface or the children position on the right of the interface, may be highlighted by clicking it with a mouse pointer, in which case it becomes the target object for buttons (363), (364) and (365) to act upon. The effect these buttons have is described later in this document.

Typically the fact that a class object is highlighted would be designated through applying a colour effect to the currently highlighted object. The dotted line around the patent class object (361) in this diagram is indicative of an applied highlight. Another consequence of highlighting a patent class object is that panel (362) is updated to display additional more detailed information associated with the object. The information shown in this panel is information associated with the object type, but may show different data fields for different object types (e.g. for objects other than patent classes).

In the preferred embodiment the object types include patent classes (which can represent patents or patent applications), archetype classes and classification objects.

In the preferred embodiment, when an patent class is highlighted, the information panel shows the patent application or granted patent number (ObjectID), Title, Novelty, Application and Benefit.

If the panel does not provide enough space for the display of all the information associated with the current object, the additional information can be scrolled into view by use of the scroll bar (367).

In the preferred embodiment when an archetype class is highlighted, the information panel shows the ObjectID of the archetype class, Title, Description, mandatory behaviours and variables/attributes and optional behaviours and variables/attributes. FIG. 8 provides an example of the panel display (801) when an archetype class is highlighted.

Other data may be displayed when the currently highlighted object is other than an archetype class.

The area underneath the “parents” heading is used to display the parents of the current object (354). In FIG. 5, ARC1016 and ARC1019 are illustrated (353). The user may double click any of these with a mouse pointer to designate the object as the current object or first highlight it and then select the “make current” button (364) to achieve the same result. In this event, the object is shown in the current object position and any parents it has are shown under the “parents” heading and any children it has under the “children” heading. If there are more parent objects than can be displayed in the space available, the content of area (368) becomes scrollable by use of the scroll bars (366) on the right hand side of the panel and the scrolling action allows access to the additional data.

The children list (360) provides a list of objects that are children of the current object. These may include (but are not limited to) archetype classes and patent classes. Like the parents list the user may double click any of these with a mouse pointer to designate the object as the current object, in which case the object is shown in the position of (354). The parents and children areas are updated to reflect the parents and children of the new current object. If there are more child classes than can be displayed in the space available, the list becomes scrollable by use of the scroll bars (366) on the right hand side of the panel.

Any of the displayed objects can also be made current by using the mouse pointer to first highlight the object and clicking the “make current” button (364) with the mouse pointer.

Each class object, including invention class objects, may have more detailed data associated with it than window 351 (including panel 362) can display. In the preferred embodiment the more detailed data may be accessed through activating the “view detail” button (365). (FIG. 10 shows the resulting pop-up form and further description regarding this form is given below, though access to and display of this form is not essential to the invention claimed here).

Additionally the panel (362) is used to display a selection of additional data associated with the currently highlighted object. If the user makes an object current by double-clicking it with the mouse pointer or by first selecting it and then clicking the “make current” button, behaviours defined by the currently selected class are shown at 356 and 357 in the panel labelled “behaviours”. Behaviours, if present, may be mandatory or optional.

Mandatory behaviours (356) are indicated with a square black bullet point next to them. In the preferred embodiment mandatory behaviours are associated with a class (and displayed for the current class), either because a mandatory behaviour has been defined as part of that class, or because one has been inherited as mandatory from an optional attribute included in one of the immediate parents of the class.

Optional behaviours (357) are indicated with a square selection box containing an asterisk next to them. The operation of this selection box is similar for both optional behaviours and optional variables/attributes and is described below.

The panel labelled “attributes” is similar to the behaviours panel but displays variables/attributes of the class if any are present. Variable/attribute 358 is mandatory, and variable/attribute 359 is optional. The scroll bars 366 can be used in the event the list of behaviours and/or variables/attributes is greater than can be displayed in the available screen space (368).

Selection boxes (357 and 359) are displayed to the left of optional behaviours and variables/attributes if the current class object has them. In the preferred embodiment a class has optional behaviours and variables/attributes if they have been defined for that class or if it has been defined to inherit the optional behaviours and variables/attributes of a parent class as optional.

The selection box associated with an optional behaviour or variable/attribute can be toggled between three states. The toggle action is used to select between different filter states applicable to the list of child objects. In the preferred embodiment, the first and default state of the optional behaviour or variable/attribute selection box displays an asterisk. When in this state the optional attribute has no effect on the displayed list of child objects. All child objects will be shown regardless of whether or not they inherit the behaviour or variable/attribute.

The second state is accessed by clicking the selection box once with the mouse pointer. In the second state the selection box displays a “+” sign. In this state a filter is applied to the list of child objects (360) and the display of the list is updated to reflect the filtered set. In this state a child object is only selected by the filter if it inherits the selected feature (either as optional or as mandatory).

The third state is accessed by clicking the selection box a further time with the mouse pointer. In the third state the selection box displays a “−” sign. When this state is selected, a filter is again applied to the list of child classes (360) and the display of the list is updated to reflect the filtered set. This time a child class is only selected by the filter if it does not inherit (i.e. has not been defined as having inherited) the optional feature as either an optional or a mandatory behaviour or variable/attribute.

When an object contains multiple optional behaviours and/or variables/attributes in multiple states of selection, the filter applied to the selection of the children is a logical AND between displayed classes. The effect the application of a logical AND has on the display is illustrated by the truth table shown in FIG. 9.

FIG. 9 refers to a hierarchy containing objects a, b, c, d, e and where:
a is a parent class with optional behaviour b1 and optional behaviour b2
b is a child of a and does not inherit either b1 or b2 as either mandatory or optional
c is a child of a that inherits b1 only
d is a child of a that inherits b2 only
e is a child of a that inherits both b1 (as optional) and b2 (as mandatory)
f is a child of a where the link between a and f is a link type that does not support inheritance (e.g. as is the case for the “of interest to” link type)

The rows under columns b1 and b2 in FIG. 9 show the total number of states it is possible to select. The asterisks, plus signs and minus signs in columns b1 and b2 indicate each of the selection states identified by the same symbol used in the selection box of optional behaviours and/or variables/attributes (shown at (357) and (359) in FIG. 5).

Note: class object e inherits b1 as optional and b2 as mandatory, but this has no effect on the logic for selective display. In both cases e is treated as inheriting the optional behaviour.

Returning to FIG. 5, in the preferred embodiment, clicking the selection box a third time returns it to the default state and the default selection criteria are applied to the displayed list of child classes.

Whenever any changes are made to the data content of any of the classes, or the structure of the class hierarchy, the contents of the graphical object hierarchy display panel 368 and the additional information panel 362 are updated to reflect the changes.

In the preferred embodiment a circle (370) is used to denote that a “holds” relationship type pertains between the parent and child object. Similarly a dotted line (371) indicates an “of interest to” link between the parent and child object. Other symbols and indicators can be used for other link types. A solid black line leading into the parent or child object indicates a “contains” relationship type.

FIG. 10 shows an example of the pop-up additional information form shown when the user selects the “view detail” button, to view the details of the currently highlighted object. The pop-up form is shown in two different modes. Mode (A) shows the mode of the form when the currently highlighted class in the Cognitive Object Model Browser (as shown in FIG. 5) is an invention class representing a patent or patent application. It will be evident to someone skilled in the art that the data fields shown though advisable are neither mandatory nor limiting. The cluster of industry standard window controls (202) are commonly found in an operating system such as MS Windows. If the data occupies more space than is available in the information panel area (201) scroll bars (203) allow the user to scroll the additional information into view. When the user has finished browsing the information on this form, selecting the “done” button (204) with the mouse pointer will dismiss the form.

Mode (B) shows the form in a different mode, reflecting the fact the additional information form pertains to an archetype class. In this case the fields shown in the information panel (205) reflect the data and properties associated with an archetype class.

Referring to FIG. 5, selecting the “value mode” button (372) causes the Cognitive Object Model Browser window to display additional information and a new Value Browser window to open. FIG. 14 provides an example of this alternative user interface.

FIG. 6 shows the architecture of the apparatus in the preferred embodiment, implemented as a local client/server application, built as a Windows PC program connecting to a relational database server.

A standard Windows PC client (601), running a 32-bit version of the Windows OS (607) such as Microsoft Windows XP, is loaded with the Microsoft Net framework (606). The application (602) is deployed as a stand-alone executable program, logically structured in a conventional 3-tier architecture comprising a User Interface (603), a Business Services Layer (604) and a Data Access Layer (605). The database (609) will typically reside on a separate server which hosts a relational database management system, such as Microsoft SQL Server or Oracle. Access by the program application to the data in the server is made via a local network connection (608) using a standard data access application programming interface (such as OLE-DB or ODBC).

This embodiment of the system would typically be deployed as an in-house solution for maintenance of the database, entry of new data, and general research and analysis.

Although the preferred architecture for implementing the apparatus is shown, the claimed invention may form a component part of an application containing additional features.

In FIG. 7 the apparatus is implemented in an architecture for users to access the database over a remote link (707)—typically the Internet. In its design it shares many of the component assemblies described for FIG. 6 above.

In this embodiment the client PC (701) can be any general computer device able to provide Internet browsing facilities (705). All access to data on the database (716) is provided by use of standard TCP-IP, HTTP and SOAP protocols, connecting the client application (702) including a User Interface (703) and Web Services Access Layer (704), to a Web Application (709) via Web Service Facades (710) running on the remote server (708). The Web Service Access Layer and Web Service Facades mediate communication between the User Interface (709) and Business Services Layer (711) commonly found in the conventional 3-tier application model, with the Business Services Layer and Data Access Layer (712) residing on the server. In this embodiment the web services have been implemented as Microsoft ASP.Net applications running on the Microsoft Net Framework (714) running in Microsoft Internet Information Server (713) on a Windows 2000 server (715), but since web services in general are an industry standard, the specific details of the implementation are not material to the features and functionality of the apparatus as described. The client PC may run an OS such as Microsoft Windows (706).

In the preferred embodiment, all object types contain at least the data fields shown in FIG. 11 Table A. The data types and lengths shown are practical examples only and are not mandatory nor essential to the invention. The lengths shown represent the maximum number of characters that can be stored for each field. A person skilled in the art of database design and programming would be able to select alternative equally appropriate data types and field sizes for implementing the invention. Nor are the fields exhaustive of all the fields, types or tables required to construct e.g. a relational database implementing the invention. Again a person skilled in the art of database design and programming would be able to construct an appropriate data schema for supporting the implementation of the apparatus. For classification objects, the Value field is used to store the user input monetary value of the market the classification object represents. For other object types the Value field is used to store the results of the value allocation procedure.

In the preferred embodiment patent objects also support the additional data fields identified in FIG. 11 Table B. Note: FIG. 11 Table A and Table B are not representative of a full relational database schema or the tables as they would need to be implemented on a relational database. One skilled in the art of database design and programming will be able to implement a suitable schema for storing the object hierarchies described.

FIG. 11 Table C shows fields, field types and lengths for a database table used in the preferred embodiment, to store object-object links. ParentID gives the ID of the parent object, ChildID gives the ID of the child object, link type is used to store an index number indicating the link type. Typically, as is common in the art of database programming, there will be another table defining the name of the link type for each index value this field contains and there will be an index number and name corresponding to each of the link types defined earlier in this document. The Share field is used to store either a user entered share value or an automatically allocated share value. The Share field will only contain an automatically allocated share value if the user has selected one of the available forms of automatic share allocation (described later in this document). Business logic is implemented to ensure that if the value in the Share field is user entered then the ManualShare field bit is set to true. The ManualShare field may then be used to determine if the Share field contains a user entered value or an automatically allocated value. The Value field is used to store calculated monetary values. The procedure for calculating these monetary values and the conditions under which it is executed are described below.

FIG. 12 exemplifies a shared value hierarchy and is an example of an object model hierarchy with links to classification objects representative of a market (GTS006 (301) and GTS007 (302)). In the example, objects labelled ARC1 to ARC13 and PAT0000001 and PAT00000002 are classes in an object model defining an inheritance hierarchy as understood in the art of object oriented software development (i.e. in the preferred embodiment they are linked by “contains” link types). Objects lower in an inheritance hierarchy are said to be children of the objects they are linked to higher in the hierarchy, which are said to be parents. Typically in object oriented programming, child objects inherit the behaviours and variables/attributes of their parents higher in the hierarchy, unless the behaviours and variables/attributes are made private to the parent object and an object model is used to represent the inheritance relationships existing between objects.

By contrast objects (301) and (302) are classification objects used to define technology markets and as such are not software classes or objects in an inheritance hierarchy. Classes in an inheritance hierarchy may be used to define technologies commonly found in a given technology market. By allowing the user to bins objects from the inheritance hierarchy to classification objects, the apparatus allows a user to show technologies commonly found in a technology market. The dotted lines (303) and (304) are “holds” link types and are representative of such links and it can be seen that GTS006 (301) is linked to class objects ARC1, ARC3 and ARC4.

The apparatus allows the user to define how numeric (typically monetary) value stored in a classification object will be shared out from the classification object to child objects in the inheritance hierarchy and from those children to children of the children and so on. In the preferred embodiment this value is stored in the object's Value field (see FIG. 11 Table A).

The classification object is assigned a monetary value by a user. This is the only type of object for which an absolute monetary value can be assigned. In FIG. 12 GTS006 (301) has been assigned a value of $10 m. “Holds” links may be configured to allocate a fractional share of this monetary value from the classification object to its children. This fractional share may be a value between and including 0 and 1 and represents a fraction of the monetary value assigned to the classification object. Business logic is implemented to ensure the sum of the share allocations made by a single classification object via “holds” links to child objects cannot exceed 1. If the shares add up to less than 1 then the classification object is said to retain a share of the value which for our purposes we call the retained share. The sum of the shares for GTS006 add up to 1, so in the example given, GTS006 does not have a retained value. If an object in the inheritance hierarchy has children, it too can be configured to allocate a share of its allocated value to its children, and so on until no further shares are allocated to child objects or the bottom of the hierarchy is reached.

FIG. 12 provides an example of a hierarchy where GTS006 has links (303) to ARC1, ARC3 and ARC4. These links define that GTS006 shares 0.25 of its monetary value ($2.5 m) with ARC1, 0.5 of its value ($5 m) with ARC3 and 0.25 of its value ($2.5 m) with ARC4. GTS007 also has links (304) to child objects and these links ensure that 0.5 of its monetary value is shared with ARC4 ($2.5 m) and 0.5 with ARC5 ($2.5 m). Note: the value allocated to ARC4 is the sum of the values allocated from GTS006 and GTS007. ARC1, ARC4 and ARC5 have child objects (objects linked by a “contains” link) and in turn allocate a share of the value they have been allocated to those child objects

In the preferred embodiment, value shares can be allocated by just two object-object link types. The first is a “holds” link type, which is used to link classification objects to other objects in the hierarchy. (303) and (304) are instances of “holds” link types. The second is a “contains” link type, which is used to define inheritance relationships. (306) indicates a “contains” link type as do the other lines connecting archetype and patent objects to archetype objects in FIG. 12. In the preferred embodiment “holds” and “contains” link objects are used to store share values. The share values are used to calculate a monetary value allocation by multiplying the monetary value assigned to the parent with the share value. In the preferred embodiment this monetary value allocation is stored in the Value field of the link object and the child object is allocated a monetary value equal to the sum of all monetary values stored in links to its parents.

If the sum of the share values allocated by a parent object to its child objects is less than 1, the object is said to retain a share. In the preferred embodiment, retained share is not stored in the database or objects, but dynamically calculated using the stored data when required for display.

When a market value (i.e. the monetary value assigned to a classification object) is added, deleted or changed or when shares allocated through object links are added, deleted or changed, the values allocated to objects below the changed object in the hierarchy will often need to be recalculated if they are to remain an accurate reflection of allocated value. In the preferred embodiment an UpdateValue procedure is called to re-calculate the value allocation due to each child object whenever such changes are made.

In the preferred embodiment the UpdateValue procedure works as follows:
If an object's value is added or changed, for each link the object has with a child object, the share allocation is calculated based on the link's share and the result is stored in the link's Value field.
Next the procedure determines the value each child object is allocated. The value that a child object is allocated can be received from more than one parent link, so for each child object the procedure sums the value of all its parent links (including the updated link) and stores the result in the child object's Value field.

The procedure is executed again for each child object which has had its value changed, resulting in the recursive execution of the procedure and the recalculation of object values cascading down through the hierarchy until no further shares are allocated to child objects (either because there are no further child objects, or because the shares have not been defined). One skilled in the art of software programming will recognise that a variety of standard programming techniques can be applied to ensure the recursive execution of the procedure is optimised to minimise the chance of exceeding system memory limits.

In an alternative embodiment, the value stored in the child of an updated link could be determined by adding to it the difference between the link object value prior to update and the link object value after update. However, this is not the preferred approach. If for any reason the hierarchy data has been corrupted, or if there has been any prior failure in the execution of value calculations this alternative embodiment is more likely to perpetuate error.

In the example given in FIG. 12, it can be seen ARC11 receives an allocation of value from three different routes through the hierarchy:
1. It receives value from GTS006 via ARC1 to ARC2 to its first parent ARC7.
2. It receives value from GTS006 via ARC4 to its second parent ARC8.
3. It receives value from GTS007 via ARC4 to its second parent ARC8.

The total allocation for ARC11 is therefore $1.2 m. However, ARC11 allocates 80% of its value to ARC13, retaining 20%. The retained value of ARC11 is therefore $240,000.

The apparatus further allows the entry of constraints. In the example of FIG. 12, constraints have been entered for objects ARC5 and ARC8. A constraint limits the share of an object's value that may be allocated to its children. If a constraint is set, the sum of the shares allocated to children cannot exceed the constrained value. In the preferred embodiment, if the constraint is set to 0, it is ignored or treated as though the constraint were equal to 1. If a constraint is set such that its value is less than 1 but greater than 0, then the object necessarily retains a share equal to at least 1 minus the constraint value. Constraints are typically used to constrain the share of value a parent object allocates its children through automatic allocation.

In the preferred embodiment objects may only be linked to the classification object when those objects are not in a parent-child relationship each with the other (i.e. only when they do not have a parent-child inheritance relationship). In the preferred embodiment, business logic is implemented such that children of objects allocated a share of the value of the market defined by the classification object, may receive a share of value from those parents but may not themselves be linked directly to the classification object. Note that in FIG. 12 none of the shaded objects linked to GTS006 are in a parent child relationship with each other in the inheritance hierarchy. The business logic would prevent ARC2 from being related to GTS006 because GTS006 already has a link with ARC2's parent object.

In the preferred embodiment of the invention an object can be configured such that any value or values it is allocated may be allocated to its child object or objects automatically and that the share allocated on an automatic basis is weighted, where the weighting is determined by data contained within the child object. The sum of all the weighted shares allocated to child objects will not exceed 1, or if a constrained allocation has been configured, will not exceed the value of the constrained allocation.

In the preferred embodiment a user can enter a share for links to a limited number of child objects of a given parent and then choose to allow shares to be allocated on an automated basis to the rest. In this event a leftover share is calculated by subtracting the sum of the user allocated shares from the value of a constrained allocation if one has been configured for the parent, or from 1 if there is no constraint. A proportion of this leftover share is allocated to the remaining child objects of that parent. The sum of the automatically allocated shares will equal no more than the value of the leftover share.

In the preferred embodiment the method by which the automatic allocation of shares is made is user selectable. In the preferred embodiment, one of the selectable methods is to simply divide the leftover share by the number of remaining child objects and allocate the result to each of the remaining child object links.

However the options for automatic allocation also include means to automatically weight (vary) the allocated share that a remaining child object receives. Separate options apply different automated means for calculating share weightings and are dependent on data contained in the remaining child objects. As before the total of the weighted shares will equal the leftover share.

In the preferred embodiment, the method for automatically allocating a share to a child object in a set of child objects related to a given parent object (which may be e.g. all the child objects of a first object that have not been allocated a share by a user) may be any of the following:
1. automatically allocated share using equal division:

$${S}_{n} = \frac{L}{{O}_{n}}$$

where
Sₙ=share allocated to object n
L=leftover share
O=number of child patent objects in the set
2. automatically allocated share using weighting based on number of claims:

$${S}_{n} = L \times \frac{{C}_{n}}{{C}_{t}}$$

where
Sₙ=share allocated to object n
L=leftover share
Cₙ=number of claims in child patent object n
Cₜ=total number of claims in all the child patent objects in the set
3. automatically allocated share using weighting based on number of forward citations, the forward citations for a given patent being references from other patents to the given patent citing the given patent as prior art:

$${S}_{n} = L \times \frac{{F}_{n}}{{F}_{t}}$$

where
Sₙ=share allocated to object n
L=leftover share
Fₙ=number of forward citations for child patent object n
Fₜ=total number of forward citations for all the child patent objects in the set

In alternative embodiments additional weighting methods may be used:
4. automatically allocated share using weighting based on index value which is specified by the user individually for each object separately:

$${S}_{n} = L \times \frac{{V}_{n}}{{V}_{t}}$$

where
Sₙ=share allocated to object n
L=leftover share
Vₙ=index value specified by the user for child patent object n
Vₜ=sum of index values for all the child patent objects in the set
5. automatically allocated share using weighting based on a weighted aggregation of weightings, where individual separate weighting factors are specified by the user for each of a number of weighting bases, the weighting bases being chosen from number of claims, user-specified index value, forward citations or other basis:

$${S}_{n} = L \times ( \frac{{W}_{C} {C}_{n}}{{W}_{t} {C}_{t}} + \frac{{W}_{V} {V}_{n}}{{W}_{t} {V}_{t}} + \frac{{W}_{F} {F}_{n}}{{W}_{t} {F}_{t}} + … + \frac{{W}_{X} {X}_{n}}{{W}_{t} {X}_{t}} + … )$$

where
Sₙ=share allocated to object n
L=leftover share
W_{C}=weighting factor for number of claims basis
W_{V}=weighting factor for index value basis
W_{F}=weighting factor for number of forward citations basis
W_{X}=weighting factor for other basis (basis x)
Cₙ=number of claims in child patent object n
Cₜ=total number of claims in all the child patent objects in the set
Vₙ=index value specified by the user for child patent object n
Vₜ=sum of index values for all the child patent objects in the set
Fₙ=number of forward citations for child patent object n
Fₜ=total number of forward citations for all the child patent objects in the set
Xₙ/Xₜ=normalised weighting for basis x

Table 1 lists the share allocation ratios for an example set of patents where the shares are allocated to each patent according to the number of citations.

Table 2a and Table 2b list the share allocation ratios for an example set of patents where the shares are allocated to each patent according to a weighted aggregation of weightings where individual separate weighting factors are specified for weighting according to number of claims, user-specified index value and forward citations.

| | Cₙ | Sₙ/L |
|---|---|---|
| P₁ | 16 | 0.16 |
| P₂ | 25 | 0.25 |
| P₃ | 12 | 0.12 |
| P₄ | 12 | 0.12 |
| P₅ | 35 | 0.35 |
| total | 100 | |
| (Cₜ) | | |

TABLE 1
Example share allocation ratios for a set of 5 patents where
the leftover share L is to be divided up between patents
P₁, P₂, P₃, P₄, P₅ according to how many
claims Cₙ there are in each patent

| | C | V | F | total |
|---|---|---|---|---|
| Wₙ | W_{c} = 5 | Wᵥ = 2 | W_{F} = 3 | Wₜ = 10 |

TABLE 2A
Example weighting factors for number of claims basis,
index value basis and forward citations basis

| | Cn | Vₙ | Fₙ | Cₙ/Cₜ | Vₙ/Vₜ | Fₙ/Fₜ | Sₙ/L |
|---|---|---|---|---|---|---|---|
| P₁ | 16 | 10 | 12 | 0.16 | 0.5 | 0.24 | 0.354 |
| P₂ | 25 | 3 | 10 | 0.25 | 0.15 | 0.2 | 0.185 |
| P₃ | 12 | 3 | 10 | 0.12 | 0.15 | 0.2 | 0.159 |
| P₄ | 12 | 3 | 13 | 0.12 | 0.15 | 0.26 | 0.177 |
| P₅ | 68 | 1 | 5 | 0.35 | 0.05 | 0.1 | 0.125 |
| total | Cₜ = 100 | Vₜ = 20 | Fₜ = 50 | | | | |

Table 2b. Example share allocation ratios for a set of 5 patents where the leftover share L is to be divided up between patents P₁, P₂, P₃, P₄, P₅ according to number of claims, index value and forward citations bases with user specified weighting factors shown in Table 2a

FIG. 13 provides an example of a hierarchy where shares have been allocated by a user to some of the child objects of ARC4, and automatically allocated to the remainder. Shares have been user allocated to ARC8 and PAT00000001 and automatically allocated to patent objects PAT00000002 to PAT00000005 on a weighted share basis based on the number of claims the patents include. The sum of the shares allocated to all the child objects may not exceed 80% because object ARC4 has an allocation constraint of 80% limiting the shares that may be allocated to its children. Thus 20% is available to be shared automatically between the set of child objects for which a user allocation has not been made.

In the preferred embodiment, a user interface allows a user to view the share of value an object receives from a classification object (defining a market). In one embodiment of the invention this may be less then the total value allocated to the object if the object inherits value from more than one classification object.

The new Cognitive Object Model Browser window is illustrated by FIG. 14 and works substantially in the same way as the one illustrated in FIG. 5. In the preferred embodiment, when the new Cognitive Object Model Browser window opens, the current object remains the same as was shown in the previously described browser window. However the new window displays some additional information and allows the user to edit the share of value that an object can pass to its children or that a classification object can pass to objects in the inheritance hierarchy. In addition to the new Cognitive Object Model Browser interface, a pop-up value browser window opens (331) and, if the current object (325) inherits a share of value from the selected classification object, a pie chart is displayed (338), providing a breakdown of how the current object distributes its allocated value to its children. The pie chart contains as many segments as there are children inheriting value from the current object, plus if the current object retains any share, a segment representing the value of the retained share (335). It will be understood that sometimes the area a child segment covers may be so small as to preclude display of an object ID and percentage share within the segment.

In the preferred embodiment calculation is automatic, such that if at any time changes are made to an object's share or the value an object is allocated by its parent, a procedure is executed to update the displayed values. Changes to a market value, allocated share, or the number of shares will all trigger the recalculation process.

As is conventional with windowing operating systems the user can position windows (331) and (321) however the user sees fit. If the current object is directly related to the selected classification object, or if the current object is a child object inheriting from objects related to the selected classification object, the pie chart shows the value allocated to the current object (339) along with its ID and title. As already mentioned, lack of space may preclude the display of the child's ID in every pie segment.

If the current object has no child objects it will retain 100% of any value it has been allocated and the pie chart will be visible but contain no segments. The ID of the current object is displayed at (339) as well as the value it has been allocated from one or more parent objects or from one or more classification objects. It can be seen that the current object (ARC1012) has a value of $75 million. For each segment in the pie an ID is shown, indicating which child object the segment represents and if the current object has any retained share, a segment is shown containing the current object ID and indication of the retained share (324).

The shaded segment (334) is representative of a highlight and corresponds to the object that is currently highlighted in the Cognitive Object Model Browser window (327). If the user selects another object in the children list, the appropriate segment is highlighted in the Value Browser window.

If the user selects a new current object the Value Browser is updated to show the share allocations made by the new current object. The circle symbol (323) on the link between the object GTS001 and ARC1012 is representative of a “holds”-type link object. A “holds”-type link object is used to allocate a share of the value of a classification object to an object in the cognitive object model hierarchy. Different symbols may be used to indicate different link types and the exact symbol used is immaterial to the invention.

The Cognitive Object Model Browser also displays the value allocated to each child object in a column on the right of the browser (328).

If a user clicks a segment in the Value Browser pie chart with a mouse pointer, the corresponding child object is highlighted in the cognitive object model hierarchy, or if the retained value segment (335) is present and clicked, the current object (325) is highlighted.

Links between the child objects (326) and the current object display the percentage share allocation from the current object to the child object. The share of the highlighted object may be edited by selecting the “edit share” button (330). In this case the user may use the keyboard to enter a share value for the link between the current object and the currently highlighted child object. The user is restricted to entering values which, if added to other share values already entered by the user, will not add up to more than 1 (25% being equivalent to a share of 0.25). If an object's share is adjusted, then the Cognitive Object Model Browser window and Value Browser window are refreshed. The child object's values are recalculated using the UpdateValue procedure described earlier in this document. The “edit share” button is greyed out (unavailable) when the current object is selected. In the preferred embodiment, if a share value is 0% then no share value is shown on the link.

If the current object has optional behaviours or variables/attributes, selection boxes (340) and (341) may be used to filter the displayed children. If a filter is applied the number of displayed child objects may be less than the total number of child objects related to the current object.

In the preferred embodiment, when the list of child objects has been filtered, the pie chart current object ID (339) is prepended with the words “subset of” such that the text in the current example will read “subset of ARC1012”, and the display will be updated to show a value we shall call the subset total, i.e. the sum of the values the current object allocates to the displayed children plus the current object's retained share.

Additionally the figure for the percentage share displayed in each segment of the pie chart and on the links between the current object and the child object will be calculated. The percentage figure displayed will equal the value allocated to the child divided by the subset total multiplied by 100.

In the preferred embodiment, the “toggle breakdown” button (337) changes the basis on which the pie chart is segmented. The first time the button is clicked, the pie chart shown in FIG. 16 (342) is updated to display a breakdown of the current object's children by assignee.

By default shares are only allocated to a child object if the user specifies they should be. However in the preferred embodiment, the user can also choose to apply automatic share allocation to remaining child objects that have not had a share allocation configured. If automatic share allocation is applied, shares are applied to the remaining objects according to one of the automatic share allocation methods described earlier in this document. This is done for all the children of the current object (not just the filtered subset displayed when an optional feature selection filter is in effect).

In FIG. 14, the “auto valuation” button (320), opens the Select Auto Valuation Method window if the current object is not one that supports the allocation of value to child objects, the “auto valuation” button will have been greyed out and will not have been selectable.

FIG. 15 shows the Select Auto Valuation Method window (381). This window presents the user with four selectable options (382) allowing one of the three auto valuation methods of the preferred embodiment to be selected or, if “none” is selected, enabling the auto allocation of shares to be disabled. If an auto valuation method is selected the fractional share is calculated according to the selected valuation method for each of the remaining child objects and this share is stored in the link between the current object and the child object. (Note: because the share is automatically allocated, the link object's ManualShare field is left set to false.) The UpdateValue procedure is run for each of the updated child link objects. The window is modal, which means the other windows are locked and the user may not interact with them while the window is open.

If the option “none” is selected, the share allocated to each remaining child is set to 0. If the user manually allocates a share after automatic share allocation has been applied, the manual share overrides the automatic share allocation (as though the automatic share allocation had not been applied) and share values are recalculated from the parent down using the UpdateValue procedure.

The pie chart shown in FIG. 16 is segmented by first grouping together all child objects representative of patents or patent applications assigned to the same entity (typically a company ) and displaying a single segment to represent the aggregated total (343). If child objects have the same assignee as the current object and the current object has a retained value, then the retained value of the current object and the values allocated to the child objects are displayed as a single representative segment with the assignee name. If the displayed child objects are a filtered list, it is the filtered subset of child objects that forms the basis for aggregated segments.

When the pie chart is shown in this mode, there is no longer a link between pie chart segments for objects with assignee information and the highlight in the Cognitive Object Model Browser window. Selecting segments in the pie chart does not highlight objects in the main browser window and selecting objects in the main browser window does not highlight segments in the pie chart. It is no longer necessarily true that a single object in the browser corresponds to a segment in the pie chart. Clicking the “toggle” button (344) from this window will close the window and re-open the Value Browser pie chart window shown in FIG. 14.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An object oriented data processing system configured to store objects and to store definitions of relationships between the objects, and to process the objects in accordance with the defined relationships, the system being configured so as to support definitions of relationships of two types;
a first type of relationship whereby objects can be related such that one object in a hierarchy related to another object by a relationship of the first type is deemed to belong to a set defined by the other object; and
a second type of relationship distinct from the first type of relationship and whereby objects can be hierarchically related such that a child object related to a parent object by a relationship of the second type is deemed to inherit characteristics of the parent object and, to an extent specified in the relationship of the second type, a proportion of a characteristic of a further object related to the said parent object by a relationship of the first type.

2. An object oriented data processing system as claimed in claim 1 wherein the proportion is in the range from 0 to 1 inclusive.

3. An object oriented data processing system as claimed in claim 1 further comprising a user interface.

4. An object oriented data processing system as claimed in claim 3 further configured to determine a total proportion of the characteristic of the further object inherited by child objects, related to the parent object by relationships of the second type, and to output a warning to a user by means of the user interface if the total proportion is greater than 1.

5. An object oriented data processing system as claimed in claim 3 or wherein the total proportion of the characteristic of the further object inherited by child objects, related to the parent object by relationships of the second type, may be determined by a user and input by means of the user interface.

6. An object oriented data processing system as claimed in claim 1 wherein a relationship of the first type may exist between a first object in a hierarchy and a second object only if the first object is not linked to a third object by a relationship of the second type, the third object having a relationship of the second type with the first object.

7. An object oriented data processing system as claimed in claim 1 wherein the said other object represents a market value.

8. An object oriented data processing system as claimed in claim 3 wherein the said proportion may be allocated by a user and input by means of the user interface.

9. An object oriented data processing system as claimed in claim 1 wherein the said proportion may be allocated automatically.

10. An object oriented data processing system as claimed in claim 9 wherein a method for allocating the proportion is selectable by a user by means of the user interface.

11. An object oriented data processing system as claimed in claim 9 wherein the proportion is dependent on data contained within the said child object.

12. An object oriented data processing system as claimed in claim 1 wherein the said child object represents a patent or a patent application.

13. An object oriented data processing system as claimed in claim 12 wherein the said data represents a feature of the patent or patent application.
